(19) United States
(12) Patent Application Publication
(10) Pub. No.: US 2017/0019572 A1
(43) Pub. Date: Jan. 19, 2017

(54) CAMERA BASE DEVICE WITH SCREW-IN PLUG

(71) Applicant: Amaryllo International B.V., Hsinchu County (TW)

(72) Inventor: Chao-Tung Yang, Hsinchu County (TW)

(21) Appl. No.: 15/204,238

(22) Filed: Jul. 7, 2016

(30) Foreign Application Priority Data
Jul. 17, 2015 (TW) 104123157

(51) Int. Cl. H04N 5/225; H04N 5/232

(52) U.S. Cl. CPC H04N 5/2252; H04N 5/23296; H04N 5/23203

(57) ABSTRACT

Present application provides a camera base device with screw-in plug. They can be paired as two units or they can be designed as a single device. Aforementioned base device includes a retractable body and a screw-in plug. The retractable body includes a plurality of serially connected segments, and two ends of retractable body respectively connected with the screw-in plug and a connector which is used to combine the external camera device. Therefore, user may adjust the length of the retractable body to avoid the installation environment effecting the operation of the camera device.

### PRIORITY

This application claims priority benefit of Taiwan Patent Application Ser. No. 104123157 filed 2015/7/17 which is hereby incorporated herein by reference its entirety.

### BACKGROUND OF THE INVENTION

1. Field of the Invention

The present application relates of two parts forming a single device. It describes a camera base device, particularly a camera base device which is equipped with a screw-in plug and adjusted in size according to a lampshade structure.

2. Description of the Prior Art

To strengthen control over the environment, a user installs monitoring devices at important areas for recording and for the surveillance of all conditions. Moreover, technicians have to add extra wiring which supply an operating voltage to all monitoring devices but increase costs.

To address the above issue, the prior arts, Taiwan Patents: M498431, “Bulb type monitoring camera”, M496304 “Monitoring camera and monitoring camera system”; U.S. Patents: U.S. Pat. No. 6,812,970, “Video camera utilizing power line modulation”, and U.S. 20130169814, “Lamp socket type camera”, further describe a camera device with a screw-in plug. With the screw-in plug inserted into a light socket, the operating voltage can be supplied to the camera device through the plug. However, most monitor manufacturers cannot offer a monitoring device that matches various types of lampshades in actual installation environment. For a lampshade greater than a monitoring device in size, clear video data may not be transmitted from the monitoring device because the lampshade obstructs the viewing angle of the monitoring device.

As described previously, monitoring devices based on the prior arts are not adjusted in size for various types of lampshades and reduce the acceptability of consumers for a camera device with a screw-in plug. Therefore, how to provide a camera base device with its size adjusted according to a lampshade structure is a technical issue to be addressed by the persons skilled in the art.

### SUMMARY OF THE INVENTION

To overcome the above problem, the present application offers a camera base device with a screw-in plug which is adjusted in size according to installation environment.

To achieve the aforementioned objective, the present application provides a camera base device with a screw-in plug. The camera base device comprises of a retractable body and a screw-in plug wherein the retractable body is comprised of a plurality of serially connected retracting segments which has two ends, which are defined as a plug-in end and a connecting end, respectively, the plug-in end links the screw-in plug and the connecting end combines external camera device through a connector.

As mentioned previously, the camera base device, which depends on the retracting segments for adjustment of the retractable body in length, matches various sizes of lampshades without the abovementioned installation problem.

### BRIEF DESCRIPTION OF THE DRAWINGS

For a better understanding of the aforementioned embodiments of the invention as well as additional embodiments thereof, reference should be made to the Description of Embodiments below in conjunction with the following drawings in which like reference numerals refer to the corresponding parts throughout the figures.

FIG. 1 is a structural schematic view of a camera base device with a screw-in plug 1 in an embodiment.

FIG. 2 is a structural schematic view for a cross section of a camera base device.

FIG. 3 illustrates a motor device in a camera base device in one embodiment.

FIG. 4 illustrates a motor device in a camera base device in another one embodiment.

FIG. 5 is a schematic view of a camera base device in another one embodiment.

FIG. 6 is a schematic view of a camera base device in another one embodiment.

FIG. 7 is a schematic view of a camera base device in another one embodiment.

FIG. 8 is a system block diagram of a camera base device in another embodiment.

FIG. 9 is a schematic view of a camera base device in another one embodiment.

FIG. 10 is a structural schematic view for a cross section of a cover body.

FIG. 11 is a schematic view which illustrates a camera base device with a screw-in plug is installed in one situation.

FIG. 12 is a schematic view which illustrates a camera base device with a screw-in plug is installed in another one situation.

### DETAILED DESCRIPTION OF THE PREFERRED EMBODIMENT

The following description is about the embodiments of the present invention; however it is not intended to limit the scope of the present invention.

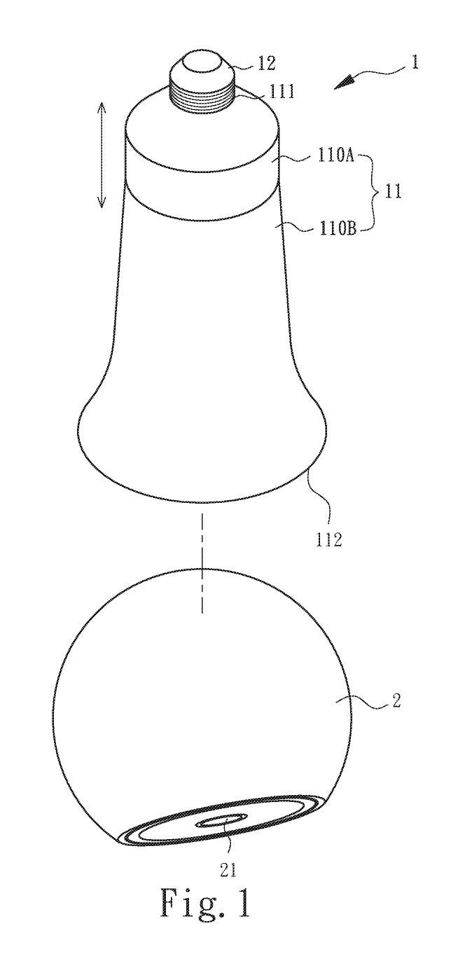

Referring to FIG. 1, which illustrates a camera base device 1 with a screw-in plug in one embodiment. The camera base device 1 is comprised of a retractable body 11 and a screw-in plug 12. The retractable body 11 is comprised of a plurality of serially connected retracting segments 110 (a first retracting segment 110A and a second retracting segment 110B). The retractable body 11 has one end defined as a plug-in end 111 and the other end defined as a connecting end 112. The connecting end 112 is configured to combine an external camera device with a connector. The screw-in plug 12 is a screwed plug conforming to the standards of Edison screws (ES).

The camera device (camera device 2) is comprised of a controlling circuit module (for example, digital circuit, micro-controller chip circuit, etc.), a camera module (with a lens 21 and a driver circuit), non-transitory memories and a communications circuit. The controlling circuit module links the camera module, the non-transitory memories and the communications circuit. The controlling circuit module is used to store images taken by the lens 21 in internal non-transitory memories or transmit images taken by the lens 21 to a server through the communications circuit for storage. The non-transitory memories might be a memory device such as flash memories or a hard disk. The communications circuit might be a wireline communications circuit (for example, network interface communications circuit, coaxial-cable interface communications circuit, fiber interface communications circuit, etc.) or a wireless communications circuit (Bluetooth, Wi-Fi, 3G/4G/5G communications circuit, etc.). The aforementioned camera base 2 and the camera device 1 can be illustrated/paired in two separated units or it can be designed as a single device.

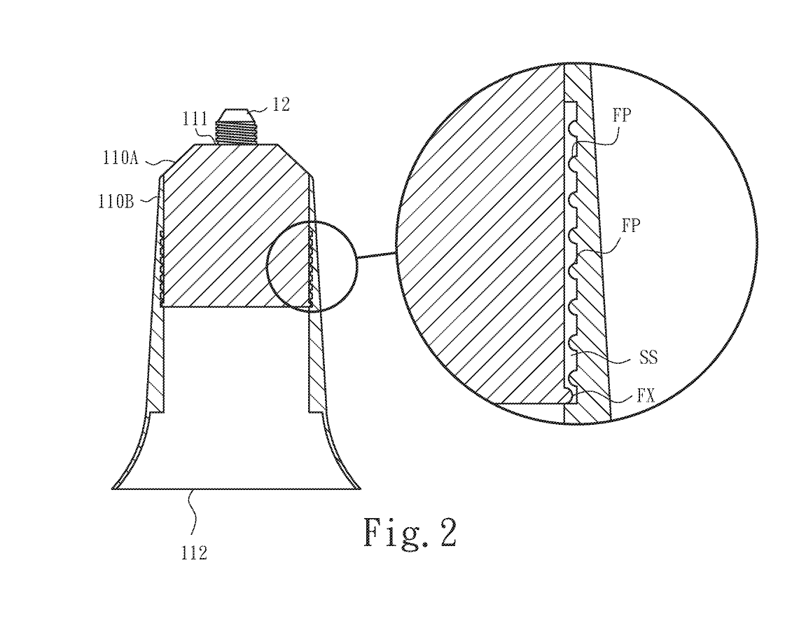

Referring to FIG. 2, which is a sectional view of the camera base device 1. The first retracting segment 110A has one portion defined as a fixed end (FX). The fixed end (FX) is held and moved in slide slots (SS) inside the second retracting segment 110B for adjustment of the retractable body 11 in length. In the slide slots (SS) is provided with at least one fixed portion (FP) (for example, bump structure, cavity structure, latch, spring, gear, etc.) by which the fixed end (FX) of the first retracting segment 110A is fixed in a fixed portion (FP) or between two fixed portions (FP) for setup of the retractable body 11 in length while moved in the fixed portion (FP) or between the two fixed portions (FP). The retractable body 11 broadens in width gradually from the plug-in end 111 to the connecting end 112. The retractable body 11 has a cross section with a curve structure and structurally matches the inside side of a lampshade 5, for example, the size of the retractable body 11 is less than the inside structure of the lampshade 5.

For the connecting end 112 with a plurality of open pores (not shown in the figure) in another embodiment, the camera device 2 also has other open pores (not shown in the figure) corresponding to the open pores on the connecting end 112. As connectors, a group of screws and nuts (not shown in the figure) are used to latch the perforate connecting end 112 and the perforate camera device 2 for combination of the camera base device 1 and the camera device 2.

For a latch (not shown in the figure) taken as a connector in another one embodiment, the camera device 2 is provided with a corresponding latch structure (not shown in the figure) by which the camera base device 1 and the camera device 2 are connected to each other.

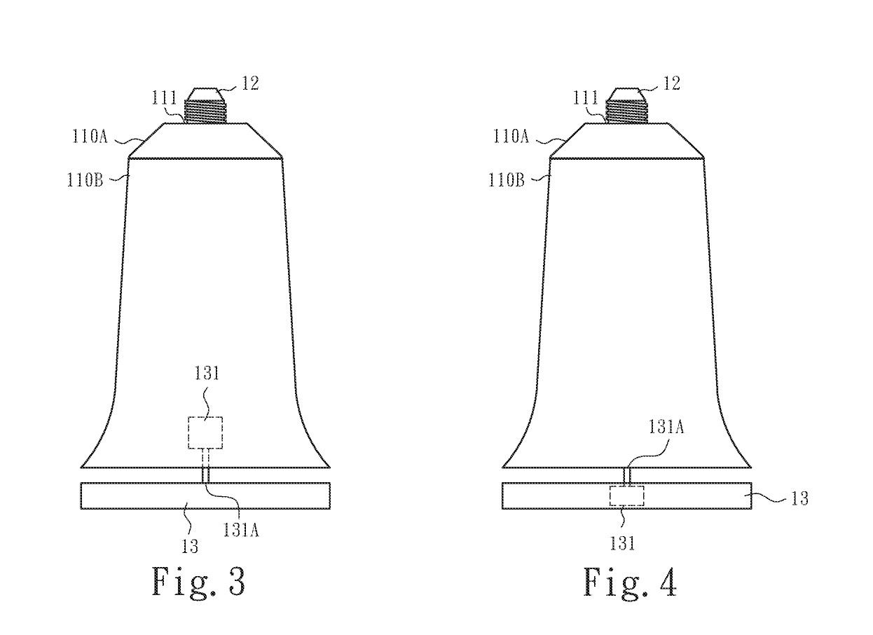

Referring to FIGS. 3 and 4, which illustrate the camera base device 1 further comprises of a rotatable platform 13 linking the retracting segments 110 for rotations of the rotatable platform 13 relative to the retractable body 11 in a rotating mode in another one embodiment. As shown in the embodiment in FIG. 3, the retractable body 11 is internally equipped with a motor device 131 which is fixed inside the retractable body 11 and has a rotating shaft with a terminal 131A fixed on the rotatable platform 13. As shown in the embodiment in FIG. 4, the rotatable platform 13 is internally equipped with the motor device 131 which is fixed inside the rotatable platform 13 and has a rotating shaft with a terminal 131A fixed on the retractable body 11. In the two embodiments, the motor device 131, which has been driven to rotate, enables the rotatable platform 13 to make rotations relative to the retractable body 11.

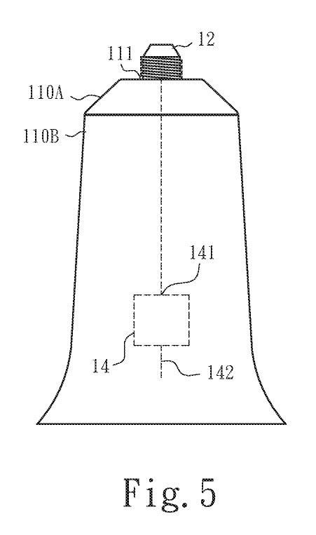

Referring to FIG. 5, which illustrates the retractable body 11 is internally equipped with an AC-DC converting circuit 14 in another one embodiment. In the AC-DC converting circuit 14, an AC input end 141 is connected to the screw-in plug 12. In the AC-DC converting circuit 14 which is electrically activated, a DC output end 142 provides post-stage circuits with a DC operating voltage.

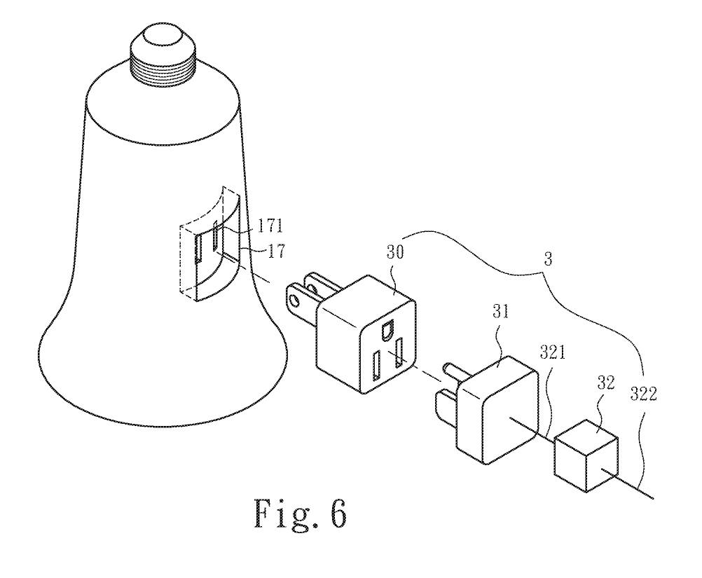

Referring to FIG. 6, which illustrates the retractable body 11 is comprised of a groove 17 recessed from the surface of the retractable body 11 inward for holding a plug structure in another embodiment. Inside of groove 17 are open sockets 171 which are electrically connected to the screw-in plug 12. In the present embodiment, the AC-DC converting circuit 14 is a removable AC-DC converting circuit module 3 which is comprised of a plug adapter 30 (an adapter for Type A plug coupling Type B plug), an AC plug 31 (Type B plug) and an AC-DC converting circuit module 32, which are cascaded with one another. In the AC-DC converting circuit module 32, an AC end 321 is connected to the AC plug 31 which is further plugged into the groove 17 and the sockets 171 therein via the plug adapter 30. A DC end 322 in the AC-DC converting circuit module 32, which is electrically activated, provides post-stage circuits with a DC operating voltage.

For the removable AC-DC converting circuit module 3 in which no plug adapter 30 is installed in another embodiment, the sockets 171 matches the AC plug 31 in specifications (for example, both the sockets 171 and the AC plug 31 are classified into but not limited to Type A or Type B).

In the present application, half-wave rectifier circuits, full-wave rectifier circuits or switch-mode rectifier circuits are available to both the AC-DC converting circuit 14 and the AC-DC converting circuit module 32.

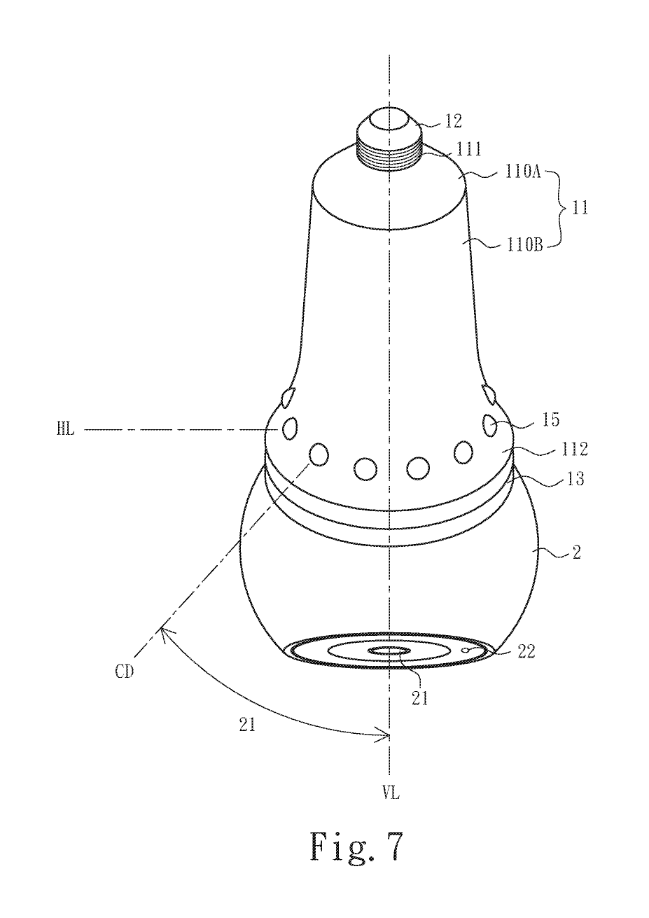

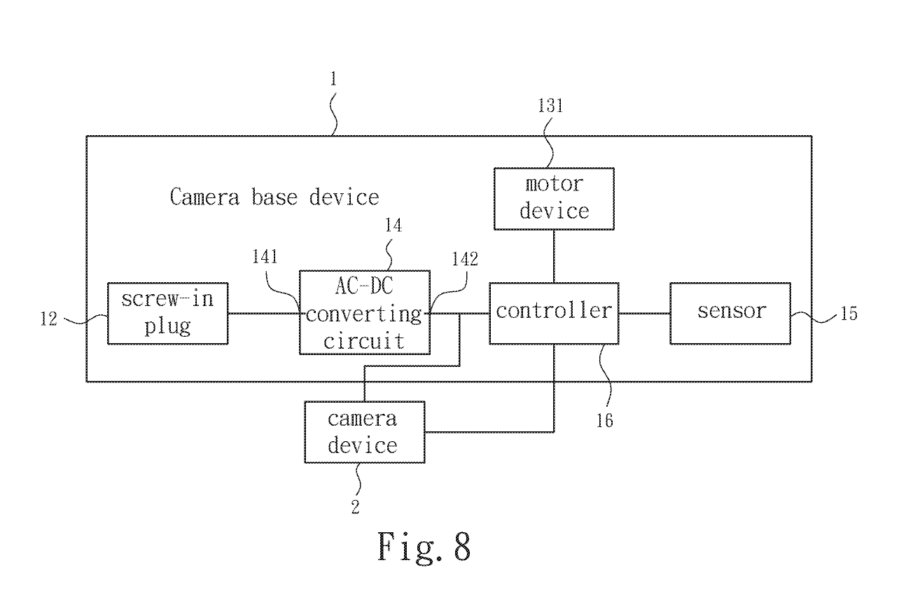

Referring to FIG. 7, which illustrates the camera base device 1 is further comprised of a plurality of sensors 15 and a controller 16 in another one (FIG. 8). The sensors 15 are embedded in positions adjacent to the connecting end 112.

Referring to FIG. 8, a system block diagram for the camera base device 1, which illustrates an AC terminal on the screw-in plug 12 is connected to the AC input end 141 of the AC-DC converting circuit 14 and the DC output end 142 of the AC-DC converting circuit 14 is connected to the power supply terminals of both controller 16 and the camera device 2. Input/output pins on the controller 16 are electrically connected to the sensors 15 and the rotatable platform 13. Power supply pins on the sensors 15 are connected to the DC output end 142 of the AC-DC converting circuit 14 for supplying an operating voltage.

In another embodiment, the AC-DC converting circuit module 32 in the removable AC-DC converting circuit module 3 replaces the AC-DC converting circuit 14. In the screw-in plug 12, an AC terminal is electrically connected to the AC end 321 of the AC-DC converting circuit module 32 and the DC end 322 of the AC-DC converting circuit module 32 is connected to power supply terminals of both the controller 16 and the camera device 2.

The sensors 15 circumferentially installed on the retractable body 11 establish a specific monitoring scope according to the positions of the sensors 15. The controller 16 analyzing a sensing result from the sensors 15 is able to detect any target 7 coming within the monitoring scope and a direction of the target 7, enabling the rotatable platform 13 according to the sensing result from the sensors 15 and aiming the lens 21 of the camera device 2 at the target 7 for shooting.

The controlling circuit module in the camera device 2 is further connected to the controller 16 and enables the camera module to shoot an external target according to a sensing result from the controller 16. The controlling circuit module, which received a plurality of images from the camera module and analyzed pixel distribution of the images, decides any target coming within a monitoring scope and further enables the camera device 2 to track the target after analyzing pixel variations among the images for movement of the target. Moreover, referring to FIG. 7 again, which illustrates the camera device 2 is further comprised of a laser transmitter 22 connected with the controlling circuit module. The controlling circuit module further enables the laser transmitter 22 to emit a laser beam toward a target for warning effect.

The sensors 15 are chosen from but not limited to temperature sensors, infrared sensors, ultrasonic sensors, radar sensors, etc. The controller 16 is an electronic component with computational capability such as Application Specific Integrated Circuit (ASIC) chip, microprocessor, etc. In another embodiment, each of the sensors 15 recessed in the retractable body 11 is installed according to a configuring direction (CD) which forms an included angle with the vertical line (VL) of the retractable body 11. The camera base device 1 is configured to establish a monitoring scope with the included angle adjusted. In detail, the configuring direction (CD) is defined between the horizontal line (HL) and the vertical line (VL).

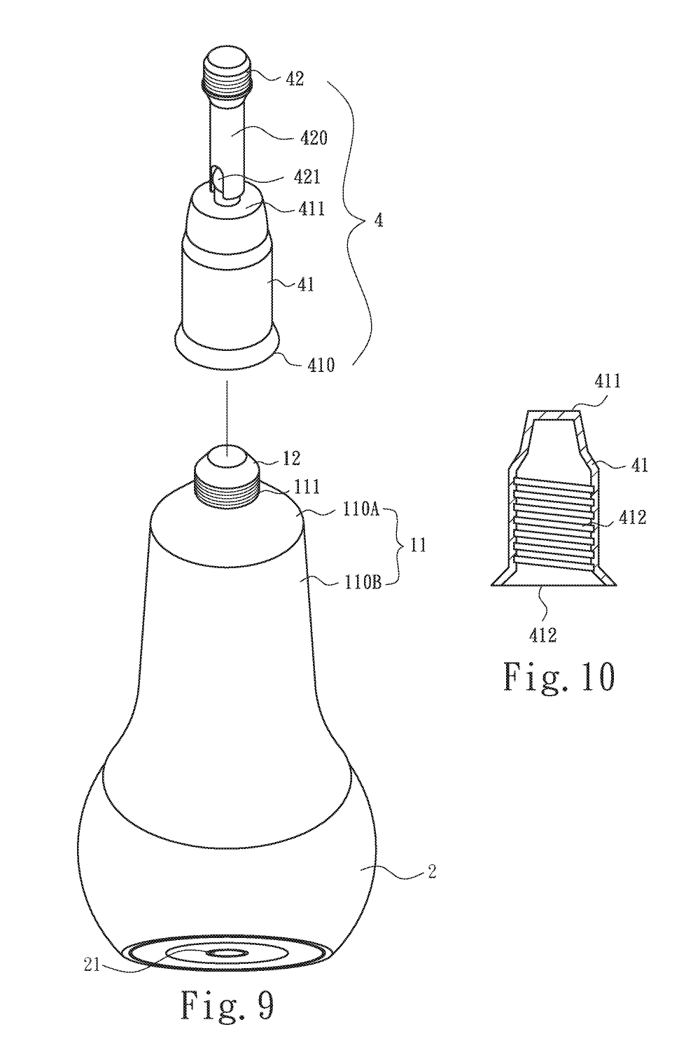

Referring to FIG. 9, which illustrates the camera base device 1 is further comprised of an extending connector 4 in another embodiment. The extending connector 4 is comprised of a cover body 41 and an extending screw-in plug 42.

Referring to FIG. 10, a sectional view of the cover body 41, which illustrates the cover body 41 from a cover opening 410 internally develops a screw-in socket 412 toward a cover cap 411 and the screw-in socket 412 structurally matches the screw-in plug 12. The extending screw-in plug 42 electrically connected to the screw-in socket 412 has an extended connecting portion 420 linking the cover body 41 for adjustment of the extending screw-in plug 42 relative to the cover body 41. The extended connecting portion 420 is a hollow component in which a wire linking the extending screw-in plug 42 and the screw-in socket 412 is installed.

In another embodiment, the extended connecting portion 420 has an extended connecting end 421 which is a pivot component (for example, shaft pivot, sphere pivot, etc.) used to link the cover body 41. In a further embodiment, the extended connecting portion 420 is a bendable component (for example, tube, serpentine coil, gooseneck, etc.).

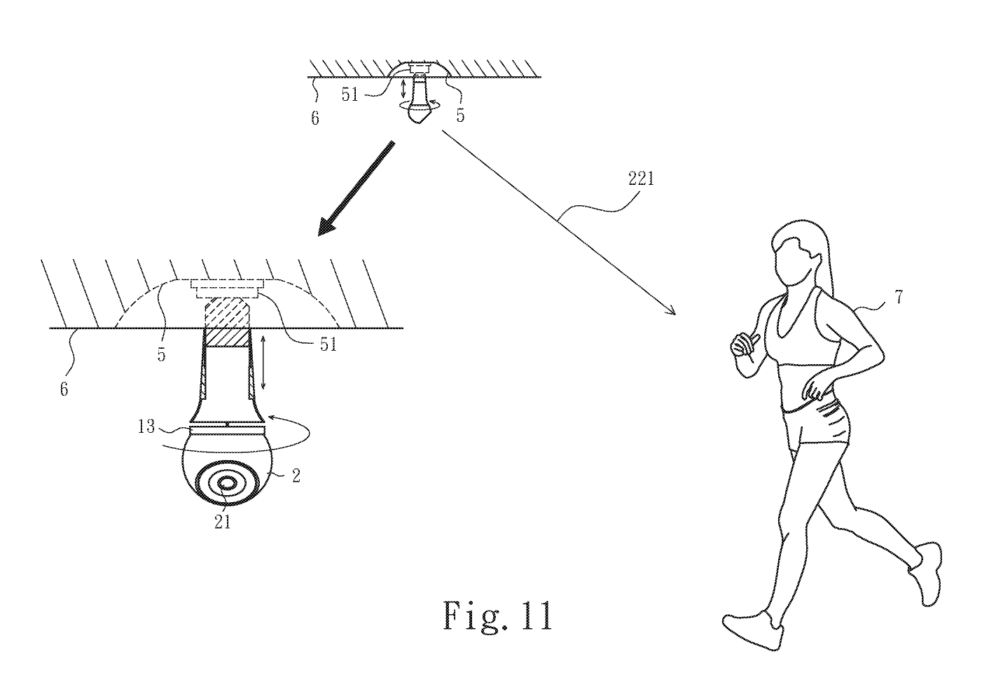

Referring to FIG. 11, which is a schematic view illustrating a camera base device with a screw-in plug is installed in one situation. As shown in FIG. 11, the lampshade 5 and a light socket 51 are mounted on a ceiling 6. With the screw-in plug 12 of the camera base device 1 inserted into the light socket 51, the retractable body 11, which is adjusted in length by a user, matches the size of every lampshade 5. The controller 16 analyzing a sensing result from the sensors 15 detects any target 7 coming within a monitoring scope and a direction of the target 7, regulating operation of the rotatable platform 13, and aiming the lens 21 of the camera device 2 at the target 7 for dynamic tracing and shooting. In addition, the camera device further drives the laser transmitter 22 (FIG. 7) to emit the laser beam 221 toward the target 7 in a whole course and gives the target 7 a hint of not entering a specific area.

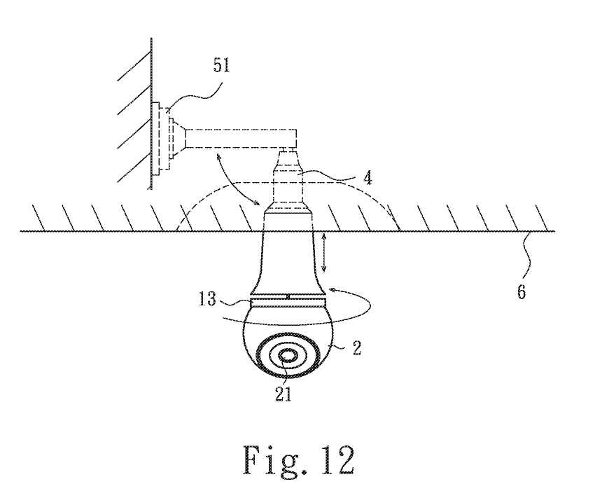

Referring to FIG. 12, which is a schematic view illustrating a camera base device with a screw-in plug installed in another situation. In some cases the light socket 51 is not situated above the lampshade 5 (for example, the light socket 51 is next to both sides of the opening of the lampshade 5), the camera base device 1 matches the extending connector 4 to flexibly adjust a position of the camera base device 1.

The above application is related to the detailed technical contents and inventive features thereof. People skilled in this field may proceed with a variety of modifications and replacements based on the applications and suggestions of the invention as described without departing from the characteristics thereof. Nevertheless, although such modifications and replacements are not fully disclosed in the above descriptions, they have substantially been covered in the following claims as appended.

What is claimed is:

1. A camera base device with a screw-in plug, comprising:
a retractable body, comprising a plurality of serially connected retracting segments, wherein one end of the retractable body is a plug-in-end and the other end of the retractable body is a connecting end, wherein the connecting end is configured to combine an external camera device with a connector, and the plug-in-end connected with the screw-in plug.

2. The camera base device as claimed in claim 1, wherein width of the retractable body gradually widens along a direction from the plug-in end to the connecting end.

3. The camera base device as claimed in claim 1, wherein cross section of the retractable body comprises curve structure.

4. The camera base device as claimed in claim 2, wherein size of the retractable body is small than inside size of a lampshade.

5. The camera base device as claimed in claim 1, wherein the connector comprises a latch structure for combining the camera device.

6. The camera base device as claimed in claim 1, wherein the connecting end further comprises a rotatable platform which is connected to the retractable body, wherein the rotatable platform further rotates relative to the retractable body in a rotating mode.

7. The camera base device as claimed in claim 6, further comprising:
a plurality of sensors, embedded in the retractable body and neighbored to a position of the connecting end; and
a controller, electrically connected to the sensors and the rotatable platform device, wherein the controller further enables the rotatable platform to rotate according to a sensing result of the sensors.

8. The camera base device as claimed in claim 7, wherein the sensors are recessed in the retractable body and a configuring direction of the sensor forms an angle with a vertical axis of the retractable body.

9. The camera base device as claimed in claim 7, further comprising a camera device connected to the connecting end by the connector, wherein the camera device further comprises:
a camera module;
a laser transmitter; and
controlling circuit module, connected with the camera module, the laser transmitter and the controller, the controlling circuit module further enables the camera module according to the sensing result of the controller to acquire a plurality of images from the camera module, and tracks an external target by comparing pixel distribution of the images, the controlling circuit module further enables the laser transmitter for emitting a laser beam to the target.

10. The camera base device as claimed in claim 1, further comprising an AC-DC converting circuit, wherein an AC input end of the AC-DC converting circuit electrically connects to the screw-in plug.

11. The camera base device as claimed in claim 1, wherein the retractable body recesses a groove space from surface of the retractable body to inner space of the retractable body, the groove space has sufficient space to accommodate a plug structure , the groove further comprises a socket electrically connected with the screw-in plug.

12. The camera base device as claimed in claim 11, further comprising a removable AC-DC converting circuit module, wherein an AC plug of the removable AC-DC converting circuit module is configured to plug in the socket and the groove space.

13. The camera base device as claimed in claim 1, further comprising an extending connector, wherein the extending connector further comprises:
a cover body, forming a screw-in socket along a direction from an opening end of the cover body to a top end of the cover body; and
an extending screw-in plug, electrically connected with the screw-in socket, wherein an connecting portion of the extending screw-in plug connects the cover body so as to adjust position relative to the cover body.

14. The camera base device as claimed in claim 13, wherein one end of the extending connector pivotally connects with the cover body.

15. The camera base device as claimed in claim 13, wherein the extending connector is a bendable component.
